(19) United States
(12) Patent Application Publication
(10) Pub. No.: US 2025/0172814 A1
(43) Pub. Date: May 29, 2025

(54) Optical Systems with Adjustable Light Engines

(71) Applicant: Apple Inc., Cupertino, CA (US)

(72) Inventors: Dominic P. Cincione, San Francisco, CA (US); Ali Arshad, Mountain View, CA (US); Christopher Patton, San Jose, CA (US); Christopher M Scannell, San Francisco, CA (US); Brian S. Lau, Seattle, WA (US); Chih Jen Chen, San Jose, CA (US)

(21) Appl. No.: 18/917,202

(22) Filed: Oct. 16, 2024

Related U.S. Application Data
(60) Provisional application No. 63/604,033, filed on Nov. 29, 2023.

(51) Int. Cl. G02B 27/01

(52) U.S. Cl. CPC G02B 27/0176; G02B 27/0172; G02B 2027/0154

(57) ABSTRACT

An electronic device, such as a head-mounted device, may include a support structure and a display system coupled to the support structure. The display system may include a light engine that emits light into a waveguide, which in turn guides the light to an eye box. To reposition the light engine relative to the waveguide, a positioner may be included in the display system. In particular, the positioner may rotate and/or laterally translate the light engine relative the waveguide. The positioner may be a fastener that moves the light engine about a pivot point, a flexure, a hinge, a curved rail, a cam and screw, a rack and pinion, or a piezoelectric actuator, as examples. Multiple positioners may be used to move the light engine in multiple directions. The light engine may be moved manually or using a motor, such as in response to a sensor measurement.

This application claims the benefit of U.S. provisional patent application No. 63/604,033, filed Nov. 29, 2023, which is hereby incorporated by reference herein in its entirety.

### BACKGROUND

This relates generally to optical systems and, more particularly, to optical systems for displays.

Electronic devices may include displays that present images to a user's eyes. For example, devices such as virtual reality and augmented reality headsets may include displays with optical elements that allow users to view the displays.

### SUMMARY

An electronic device such as a head-mounted device may a support structure and may have one or more near-eye displays that produce images for a user. The head-mounted device may be a pair of virtual reality glasses or may be an augmented reality headset that allows a viewer to view both computer-generated images and real-world objects in the viewer's surrounding environment.

The displays may include a light engine that emits light into a waveguide, which in turn guides the light to an eye box. It may be desirable to move the light engine relative to the waveguide. For example, the light engine may shift relative to the waveguide, or it may be desirable to modify the light output from the waveguide.

To reposition the light engine relative to the waveguide, a positioner may be included in the display system. In particular, the positioner may rotate and/or laterally translate the light engine relative the waveguide. The positioner may be a fastener that moves the light engine about a pivot point, a flexure, a hinge, a curved rail, a cam and screw, a rack and pinion, or a piezoelectric actuator, as examples.

Multiple positioners may be used to move the light engine in multiple directions, if desired. For example, a first fastener may be used to rotate the light engine about a pivot point, and a second fastener may be used to translate the light engine laterally closer and further from the waveguide. Alternatively, two flexures may be used to rotate the light engine in two different directions (e.g., about two different pivot points).

The light engine may be moved manually or may be moved using a motor. If desired, the light engine may be moved automatically in response to a sensor measurement. For example, a sensor may measure a position of the light engine relative to the waveguide, and the light engine may be repositioned if it has shifted. Alternatively or additionally, a sensor may measure an output of the waveguide, and the light engine may be repositioned to adjust the output of the waveguide.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with an input coupler that receives light from a display module in accordance with some embodiments.

FIG. 3 is a top view of an illustrative display module having a light engine that can be rotated and/or translated in multiple directions in accordance with some embodiments.

FIG. 4 is a top view of an illustrative display module having a light engine that can be rotated and/or translated using a fastener in accordance with some embodiments.

FIG. 5 is a top view of an illustrative display module having a light engine that can be rotated and/or translated using a flexure in accordance with some embodiments.

FIG. 6 is a top view of an illustrative display module having a light engine that can be rotated and/or translated using a hinge in accordance with some embodiments.

FIG. 7 is a top view of an illustrative display module having a light engine that can be rotated and/or translated using a curved rail in accordance with some embodiments.

FIG. 8A is a top view of an illustrative display module having a light engine that can be rotated and/or translated using a cam and screw in accordance with some embodiments.

FIG. 8B is a front view of an illustrative cam and screw that can rotate and/or translate a light engine in accordance with some embodiments.

FIG. 9 is a top view of an illustrative display module having a light engine that can be rotated and/or translated using a rack and pinion in accordance with some embodiments.

FIG. 10 is a top view of an illustrative display module having a light engine that can be rotated and/or translated using a piezoelectric actuator in accordance with some embodiments.

FIG. 11 is a flowchart of illustrative steps that may be used to adjust a position of a light engine in accordance with some embodiments.

FIG. 12 is a top view of an illustrative display module having a light engine that can be rotated and/or translated in a first direction using a first fastener and in a second direction using a second fastener in accordance with some embodiments.

FIG. 13 is a top view of an illustrative display module having a light engine that can be rotated and/or translated in two different directions using first and second flexures in accordance with some embodiments.

### DETAILED DESCRIPTION

A system, such as a head-mounted device or other electronic device, may include one or more displays. The displays may be digital micromirror displays or other displays having one or more light engines. The light engines may emit light into an optical display element, such as a waveguide, and the light may be reflected within the waveguide until it is output from the waveguide to be viewed by a user of the device.

Because the light emitted by the light engine propagates within the waveguide to be viewed by a user, the angle and position of the light engine with respect to the waveguide may affect the final image seen by the user. In some situations, such as when the light engine becomes misaligned with the waveguide or when it is desired to modify the output of the waveguide, it may be desirable to allow for correction of this angle and/or position. In particular, the light engine may be rotatably mounted within the device, allowing the angle of the light engine relative to the waveguide to be adjusted. The adjustment may occur automatically or manually.

The light engine may be rotatably mounted using a locking goniometer or other positioner. As some illustrative examples, the light engine may be rotated about a pivot point using a fastener, a flexure, to a hinge, a curved rail, a cam and screw, a lead screw with a curved guide path, a rack and pinion, a spring, or other suitable positioner. Regardless of the positioner used, the rotational mechanism may be lockable, such as using a lock nut, a plunger and detent, reworkable adhesives, or other suitable locking mechanism(s). In this way, the angle and/or lateral position of the light engine may be adjusted relative to the waveguide, and the light engine position may be locked into place using one or more locking mechanism(s).

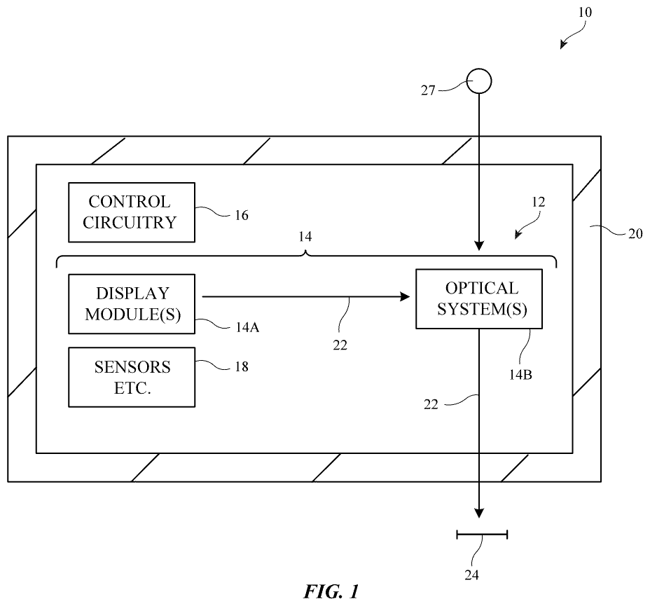

An illustrative system having a device with one or more near-eye display systems that may include a rotatably mounted light engine is shown in FIG. 1. System 10 may be a head-mounted device having one or more displays such as near-eye displays 14 mounted within support structure (housing) 20. System 10 may therefore be referred to as device 10 and/or head-mounted device 10 herein. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A (also referred to as light engines 14A herein) and one or more optical systems such as optical systems 14B. Display modules 14A may be mounted in a support structure such as support structure 20. Each display module 14A may emit light 22 (sometimes referred to herein as image light 22) that is redirected towards a user's eyes at eye box 24 using an associated one of optical systems 14B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code (instructions) may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.). In one suitable arrangement that is sometimes described herein as an example, components 18 (also referred to as sensor 18 herein) may include gaze tracking sensors that gather gaze image data from a user's eye at eye box 24 to track the direction of the user's gaze in real time.

Display modules 14A (sometimes referred to herein as display engines 14A, display modules 14A, light engines 14A, or projectors 14A herein) may include reflective displays (e.g., displays with a light source that produces illumination light that reflects off of a reflective display panel to produce image light such as liquid crystal on silicon (LCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in display modules 14A may include uLEDs, OLEDs, LEDs, lasers, combinations of these, or any other desired light-emitting components.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by components in optical system 14B may be selected so that any gap present between the displays will not be visible to a user (e.g., so that the images of the left and right displays overlap or merge seamlessly).

If desired, optical system 14B may contain components (e.g., an optical combiner, etc.) to allow real-world image light from real-world images or objects 27 to be combined optically with virtual (computer-generated) images such as virtual images in image light 22. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of object 27 and this content is digitally merged with virtual content at optical system 14B).

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

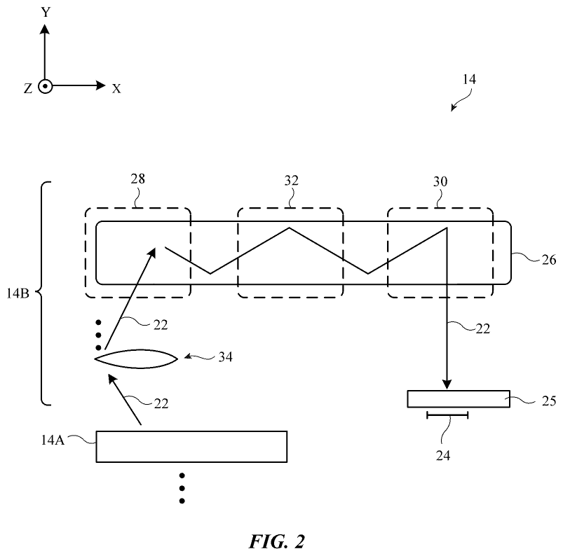

FIG. 2 is a top view of an illustrative display 14 that may be used in system 10 of FIG. 1. As shown in FIG. 2, near-eye display 14 may include one or more light engines such as light engine(s) 14A and an optical system such as optical system 14B. Optical system 14B may include optical elements such as one or more waveguides 26. Waveguide 26 may include one or more stacked substrates (e.g., stacked planar layers, curved layers, pin mirror layers, and/or slanted cut layers sometimes referred to herein as waveguide substrates) of optically transparent material such as plastic, polymer, glass, etc.

If desired, waveguide 26 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 26 may include holographic phase gratings such as volume holograms or thin-film holograms, meta-gratings, or any other desired diffractive grating structures. The diffractive gratings on waveguide 26 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles).

Optical system 14B may include collimating optics such as collimating lens 34.

Collimating lens 34 may include one or more lens elements that help direct image light 22 towards waveguide 26. Although not shown in FIG. 2, one or more prisms or other optical components may be included between collimating lens 34 and waveguide 26, if desired. Alternatively, collimating lens 34 may be omitted, if desired. If desired, display module(s) 14A may be mounted within support structure 20 of FIG. 1 while optical system 14B may be mounted between portions of support structure 20 (e.g., to form a lens that aligns with eye box 24). Other mounting arrangements may be used, if desired.

As shown in FIG. 2, light engine(s) 14A may generate image light 22 associated with image content to be displayed to eye box 24. Image light 22 may be collimated using a lens such as collimating lens 34. Optical system 14B may be used to present image light 22 output from light engine(s) 14A to eye box 24. If desired, optical system 14B may include lens barrel 25, which may include one or more lenses/lens elements, that overlaps eye box 24. In other words, light 22 may pass through lens barrel 25 to eye box 24.

Optical system 14B may include one or more optical couplers such as input coupler 28, cross-coupler 32, and output coupler 30. In the example of FIG. 2, input coupler 28, cross-coupler 32, and output coupler 30 are formed at or on waveguide 26. Input coupler 28, cross-coupler 32, and/or output coupler 30 may be completely embedded within the substrate layers of waveguide 26, may be partially embedded within the substrate layers of waveguide 26, may be mounted to waveguide 26 (e.g., mounted to an exterior surface of waveguide 26), etc.

The example of FIG. 2 is merely illustrative. One or more of these couplers (e.g., cross-coupler 32) may be omitted. Optical system 14B may include multiple waveguides that are laterally and/or vertically stacked with respect to each other. Each waveguide may include one, two, all, or none of couplers 28, 32, and 30. Waveguide 26 may be at least partially curved or bent if desired.

Waveguide 26 may guide image light 22 down its length via total internal reflection. Input coupler 28 may be configured to couple image light 22 from light engine(s) 14A into waveguide 26, whereas output coupler 30 may be configured to couple image light 22 from within waveguide 26 to the exterior of waveguide 26 and towards eye box 24. Input coupler 28 may include an input coupling prism if desired. As an example, light engine(s) 14A may emit image light 22 in the +Y direction toward optical system 14B. When image light 22 strikes input coupler 28, input coupler 28 may redirect image light 22 so that the light propagates within waveguide 26 via total internal reflection towards output coupler 30 (e.g., in the +X direction). When image light 22 strikes output coupler 30, output coupler 30 may redirect image light 22 out of waveguide 26 towards eye box 24 (e.g., back in the −Y direction). In scenarios where cross-coupler 32 is formed at waveguide 26, cross-coupler 32 may redirect image light 22 in one or more directions as it propagates down the length of waveguide 26, for example.

Input coupler 28, cross-coupler 32, and/or output coupler 30 may be based on reflective and refractive optics or may be based on holographic (e.g., diffractive) optics. In arrangements where couplers 28, 30, and 32 are formed from reflective and refractive optics, couplers 28, 30, and 32 may include one or more reflectors (e.g., an array of micromirrors, partial mirrors, louvered mirrors, or other reflectors). In arrangements where couplers 28, 30, and 32 are based on holographic optics, couplers 28, 30, and 32 may include diffractive gratings (e.g., volume holograms, surface relief gratings, etc.).

In one suitable arrangement that is sometimes described herein as an example, output coupler 30 is formed from diffractive gratings or micromirrors embedded within waveguide 26 (e.g., volume holograms recorded on a grating medium stacked between transparent polymer waveguide substrates, an array of micromirrors embedded in a polymer layer interposed between transparent polymer waveguide substrates, etc.), whereas input coupler 28 includes a prism mounted to an exterior surface of waveguide 26 (e.g., an exterior surface defined by a waveguide substrate that contacts the grating medium or the polymer layer used to form output coupler 30) or one or more layers of diffractive grating structures.

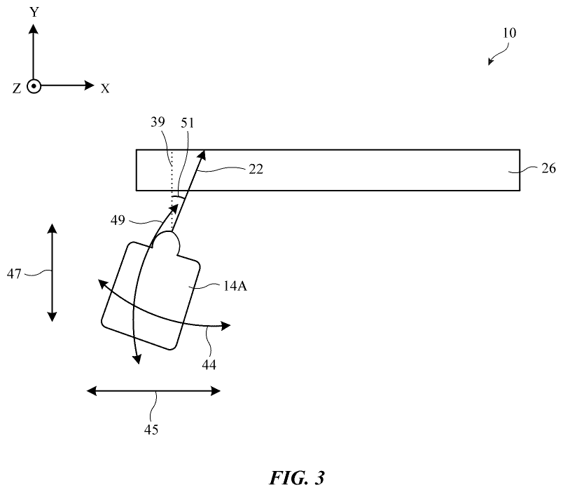

In some embodiments, it may be desirable to mount light engine(s) 14A rotatably and/or laterally so that light engine(s) 14A may be rotated relative to waveguide 26. In particular, the angle of light engine(s) 14A may be adjustable relative to waveguide 26 to ensure that the angle may be moved back to its original position/realigned as necessary after device 10 has been used and/or to allow for adjustments to the output of waveguide 26. An illustrative example of a head-mounted device with a rotatably mounted light engine is shown in FIG. 3.

As shown in FIG. 3, light engine 14A may emit light 22 at angle 51 from surface normal 39 of waveguide 26. To adjust angle 51 and/or the point at which light 22 enters waveguide 26, light engine 14A may be rotated and/or translated in one or more directions.

For example, light engine 14A may be rotated along curve 44 and/or along curve 49. In particular, light engine 14A may pivot around one or more pivot points as it moves along curve 44 and/or curve 49. In this way, light engine 14A may be rotated and angle 51 may be adjusted.

Alternatively or additionally, light engine 14A may be translated laterally in directions 45 (e.g., in the +X and −X direction) and/or in directions 47 (e.g., in the +Y and −Y directions). By moving light engine 14A in one or more of these directions, the point at which light 22 enters waveguide 26 may be adjusted, and the final image emitted from waveguide 26 may be adjusted as a result.

Although not shown in FIG. 3, light engine 14A may alternatively or additionally be rotated and/or translated with respect to the Z axis, if desired.

By adjusting the position of light engine 14A, one or more characteristics of the image produced by light engine 14A and waveguide 26, such as the image brightness, distortion, white point, resolution, or other characteristic, may be adjusted.

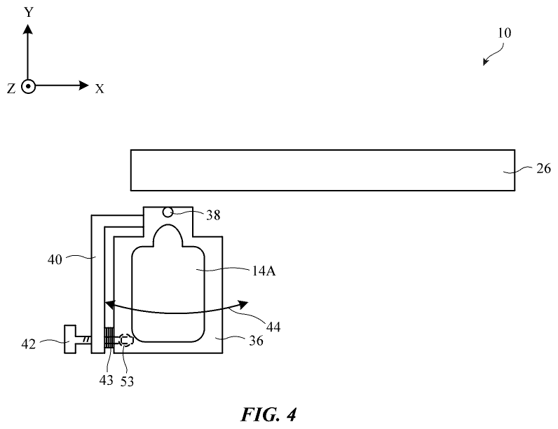

Regardless of the direction(s) in which light engine 14A is rotated and/or translated, any suitable positioner may be incorporated into device 10 to move light engine 14A. An illustrative example of a fastener that is used to move a light engine about a pivot point is shown in FIG. 4. As shown in FIG. 4, device 10 may include light engine 14A on mount 36. Mount 36 may be formed from metal, plastic, or other suitable material. Mount 36 may be coupled to structure 40. Structure 40 may be formed from a rigid material, such as metal, plastic, or other rigid material. In some illustrative embodiments, structure 40 may be a part of a support structure or housing of device 10, such as support structure 20 of FIG. 1. As a specific example, structure 40 may be a temple/stem portion of support structure 20 in embodiments in which support structure 20 has an eyeglass frame shape. However, this is merely illustrative. In general, structure 40 may be any suitable rigid structure to which mount 36 is coupled.

Mount 36 may be coupled to structure 40 using fastener 42. Fastener 42 may be a screw, pin, or other suitable fastener. In particular, fastener 42 may pass through structure 40 and through at least a portion of mount 36. Mount 36 may also rotate around rotational pivot point 38. For example, mount 36 may be coupled to structure 40 or another suitable portion of device 10 at rotational pivot point 38, such as with a shoulder screw or other fastener that allows mount 36 to rotate about point 38.

By tightening and loosening fastener 42, mount 36 may move closer to and further from structure 40 and may rotate around rotational pivot point 38. In particular, mount 36 may rotate along curve 44, thereby changing the angle of light emitted by light engine 14A into waveguide 26.

Spring 43, which may be a conical spring or other suitable type of spring, may be incorporated between mount 36 and structure 40. Spring 43 may provide a preload between mount 36 and structure 40. However, spring 43 may be omitted, if desired.

If desired, a locking mechanism may be used to lock mount 36 (and therefore light engine 14A) into a desired position. For example, a lock nut, such as lock nut 53, may be used at the end of fastener 42 to maintain the position of fastener 42. Alternatively or additionally, a series of detents may be incorporated, such as at rotational pivot point 38, to maintain the position of mount 36 at a certain angle, and/or a re-workable adhesive may be used to maintain the position of mount 36. In this way, light engine 14A may be repositioned (e.g., the angle of light engine 14A relative to waveguide 26 may be adjusted), and the position of light engine 14A may be locked at a desired position.

Although FIG. 4 shows mount 36 and light engine 14A moving along a single axis (e.g., along curve 44), this is merely illustrative. If desired, one or more additional fasteners may be incorporated into device to adjust mount 36 and light engine 14A in one or more additional directions (e.g., any of the rotational and/or translation directions of FIG. 3). For example, the additional fastener(s) may move mount 36 and light engine 14A along another curve (e.g., along a curve perpendicular to curve 44) or laterally (e.g., along the Y, Z, and/or X axis). In this way, the position of light engine 14A may be adjusted in multiple directions.

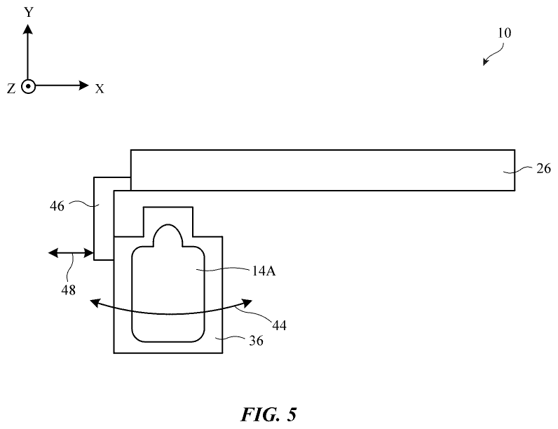

The use of fastener 42 to adjust the position of light engine 14A relative to waveguide 26 is merely illustrative. In general, light engine 14A may be mounted in any desired manner, and any suitable positioner may be used to rotate and/or translate light engine 14A relative to waveguide 26. In some embodiments, a flexure may be used to position light engine 14A. An illustrative example is shown in FIG. 5.

As shown in FIG. 5, flexure 46 (also referred to as flexure bracket 46 herein) may be coupled to waveguide 26 and to mount 36. Flexure 46 may be formed from copper, gold, silver, or other suitable flexible material. In some embodiments, flexure 46 may be flexible enough to allow light engine 14A to be adjusted, while being rigid enough to maintain its position after the adjustment of light engine 14A.

Flexure 46 may be deflected/bent along directions 48 (e.g., in the +X and −X directions). As a result, mount 36 and therefore light engine 14A may be rotated along curve 44, and an angle of light emitted by light engine 14A into waveguide 26 may be adjusted. The rigidity of flexure 46 may maintain the position of light engine 14A after it has been moved. Alternatively or additionally, a separate locking mechanism may be incorporated into device 10 to maintain the position of light engine 14A after it has been adjusted.

Although not shown in FIG. 5, flexure 46 may be combined with a fastener, such as fastener 42 of FIG. 4, to control the movement of light engine 14A further. In some illustrative examples, a fastener may be used to lock the position of light engine 14A after the position of light engine 14A has been adjusted using flexure 46. If desired, however, a fastener may be used to move light engine 14A instead or, or in addition to, locking the position of light engine 14A, if desired.

Although FIG. 5 shows mount 36 and light engine 14A moving along a single axis (e.g., along curve 44), this is merely illustrative. If desired, one or more additional flexures, fasteners, and/or other components may be incorporated into device to adjust mount 36 and light engine 14A in one or more additional directions (e.g., some or all of the directions shown in FIG. 3). For example, an additional flexure (or an extended portion of flexure 46, such as a portion of flexure 46 that extend around the back of light engine 14A) may move mount 36 and light engine 14A along another curve (e.g., along a curve perpendicular to curve 44) or laterally (e.g., along the Y, Z, and/or X axis). In this way, the position of light engine 14A may be adjusted in multiple directions.

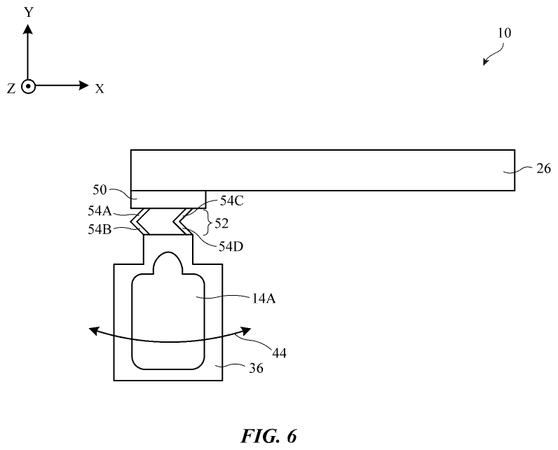

In general, any suitable positioner(s) may be used to move light engine 14A in one or more directions relative to waveguide 26. For example, as shown in the illustrative example of FIG. 6, a hinge may be used to couple mount 36 to waveguide 26.

In particular, as shown in FIG. 6, hinge 52 may couple mount 36 to optional structural member 50. Structural member 50 may be a structure formed from metal, plastic, or other material, that is adjacent to waveguide 26. Alternatively, hinge 52 may be coupled to a portion of waveguide 26 directly.

Hinge 52 may be a four-bar linkage, with bars 54A, 54B, 54C, and 54D. In this way, the angle and distance of light engine 14A may be adjusted with respect to waveguide 26. For example, light engine 14A may be rotate relative to waveguide 26 along curve 44 and/or may be moved laterally along the X axis and/or the Y axis. If desired, multiple hinge structures may be incorporated between light engine 14A and waveguide 26 to allow light engine 14A to be rotated and/or translated in multiple directions (e.g., one or more of the directions shown in FIG. 3).

The example of FIG. 6, in which hinge 52 is a four-bar linkage, is merely illustrative. In general, hinge 52 may be any suitable type of hinge to couple mount 36 to waveguide 26 and allow light engine 14A to move relative to waveguide 26.

Although not shown in FIG. 6, hinge 52 may be combined with a flexure, such as flexure 46 of FIG. 5, and/or a fastener, such as fastener 42 of FIG. 4, to control the movement of light engine 14A further.

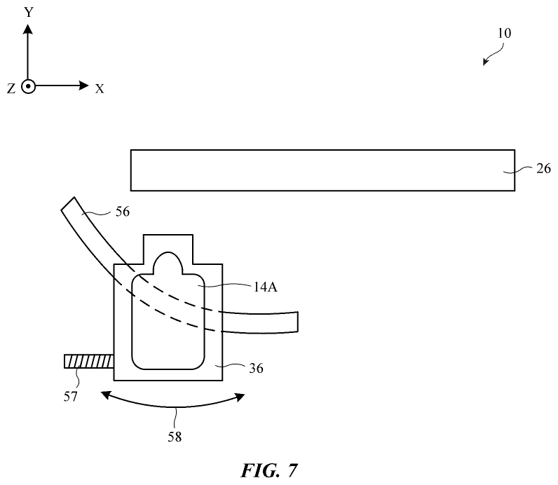

In some illustrative embodiments, mount 36 may be mounted onto a curved rail and may be moved along the curved rail to change the rotation and distance of light engine 14A with respect to waveguide 26. An illustrative example is shown in FIG. 7.

As shown in FIG. 7, mount 36 may be mounted to curved rail 56. Curved rail 56 may be formed from metal, plastic, or other suitable material. In some embodiments, curved rail 56 may be mounted to one or more support structures of device 10, or may be formed from one or more support structures of device 10.

Mount 36 may move along curved rail 56, changing the angle of light engine 14A (e.g., as light engine 14A moves along curve 58) and the distance between light engine 14A and waveguide 26 in the X and Y directions.

Optionally, lead screw 57 may be used to move mount 36 along curved rail 56. Lead screw 57 may be adjusted manually and/or may be attached to a motor that can rotate lead screw 57 to move mount 36 along curved rail 56. However, the use of lead screw 57 is merely illustrative, and mount 36 may be moved along curved rail 56 in any suitable manner.

The shape of curved rail 56 in FIG. 7 is merely illustrative. In general, curved rail 56 may have any suitable curved shape to allow light engine 14A to be adjusted rotationally and/or laterally with respect to waveguide 26.

Additionally, multiple curved rails and/or other adjustment structures (e.g., one or more of the adjustment structures of FIGS. 4-6) may be incorporated into device 10 to move light engine 14A to rotate and/or translate in multiple directions (e.g., any of the directions of FIG. 3), if desired.

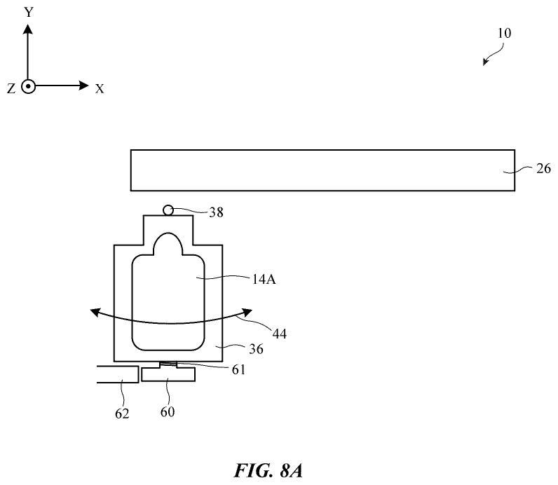

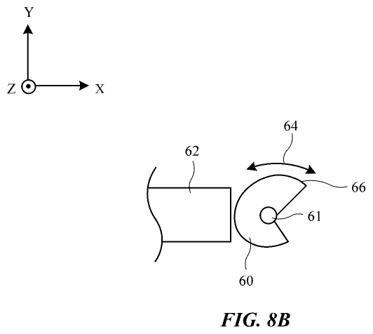

As another illustrative example, a cam and screw may be used as a positioner to rotate and/or translate light engine 14A. An illustrative example of a cam and screw that may be used to adjust light engine 14A is shown in FIGS. 8A and 8B.

As shown in FIG. 8A, cam 60 and screw 61 may be coupled to the back of mount 36, opposite waveguide 26. Structure 62, which may be a plastic structure, a metal structure, or a structure of another suitable material, may be adjacent to and in contact with cam 60.

As shown in FIG. 8B, cam 60 may have surface 66 that changes in radius along the circumference of cam 60. As a result, as cam 60 rotates (as shown by arrows 64), portions of cam 60 with a large radius will push screw 61 farther from structure 62. Additionally, screw 61 may be biased toward structure 62, such as using a spring or other biasing member, to allow screw 61 to move closer to structure 62 when portions of a cam 60 with a smaller radius are in contact with structure 62. As shown in FIG. 8A, this movement of cam 60 causes mount 36 to pivot about pivot point 38 and light engine 14A to move along curve 44. As a result, light engine 14A may be rotated and/or translated with respect to waveguide 26.

Although FIGS. 8A and 8B show cam 60 moving light engine 14A along curve 44, this is merely illustrative. In general, one or more cam structures may be incorporated into device 10 to move light engine 14A in any desired direction (e.g., in any of the directions shown in FIG. 3). For example, an additional cam and screw may be incorporated on the side of mount 36 to move light engine 14A along another curve, such as curve 49 of FIG. 3.

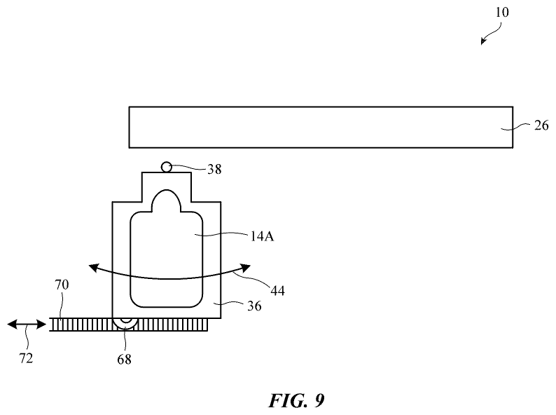

As another illustrative example, a rack and pinion may be used as a positioner to rotate and/or translate light engine 14A. An illustrative example of a rack and pinion that may be used to adjust light engine 14A is shown in FIG. 9.

As shown in FIG. 9, circular gear 68 (also referred to as pinion 68) may be coupled to mount 36 and to linear gear 70 (also referred to as rack 70). The teeth of pinion 68 may mesh with the teeth of rack 70, and pinion 68 may move along rack 70 in directions 72 (e.g., the +X and −X directions). As pinion 68 moves along rack 70, mount 36 may pivot about pivot point 38, causing light engine 14A to move along curve 44. In this way, a rack and pinion may be used to rotate and/or translate light engine 14A relative to waveguide 26.

Although FIG. 9 shows the rack and pinion moving light engine 14A along curve 44, this is merely illustrative. In general, one or more rack and pinion systems may be incorporated into device 10 to move light engine 14A in any desired direction (e.g., in any of the directions shown in FIG. 3). For example, an additional rack and pinion system may be incorporated on the side of mount 36 to move light engine 14A along another curve, such as curve 49 of FIG. 3.

Moreover, although FIG. 9 shows the rack being linear, this is merely illustrative. Rack 70 may be curved, if desired.

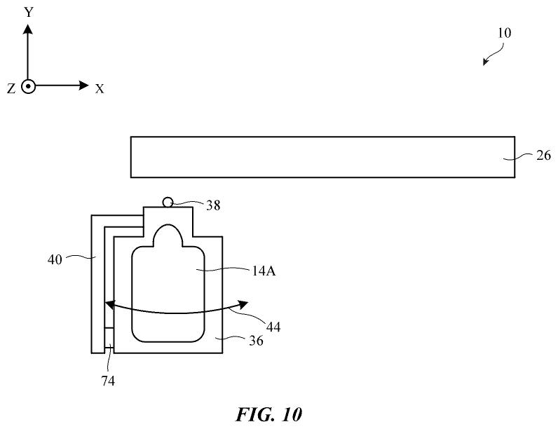

As another illustrative example, a piezoelectric actuator may be used as a positioner to rotate and/or translate light engine 14A. An illustrative example of a piezoelectric actuator that may be used to adjust light engine 14A is shown in FIG. 10.

As shown in FIG. 10, piezoelectric actuator 74 may be incorporated between structure 40 and mount 36. In operation, voltage may be applied (e.g., by control circuitry, such as control circuitry 16 of FIG. 1) to piezoelectric actuator 74, causing piezoelectric actuator 74 to expand/deflect. As a result, mount 36 may rotate about pivot point 38, and light engine 14A may move along curve 44. In this way, a piezoelectric actuator may be used to adjust the position of light engine 14A relative to waveguide 26 based on the amount of voltage applied to piezoelectric actuator 74.

Piezoelectric actuator 74 may be stable after the voltage is applied. As a result, the position of light engine 14A with respect to waveguide 26 may be stable. However, a locking mechanism, such as a fastener or adhesive, may be incorporated to maintain the position of light engine 14A relative to waveguide 26, if desired.

Although FIG. 10 shows the piezoelectric actuator moving light engine 14A along curve 44, this is merely illustrative. In general, one or more piezoelectric actuators may be incorporated into device 10 to move light engine 14A in any desired direction (e.g., in any of the directions shown in FIG. 3). For example, an additional piezoelectric actuator may be incorporated on the side of mount 36 to move light engine 14A along another curve, such as curve 49 of FIG. 3.

The positioners of FIGS. 4-10 are merely illustrative. In general, any suitable positioner(s) may be used to rotate and/or translate light engine 14A in one or more directions. As illustrative additional examples, a worm gear drive mechanism, a curved rack and pinion system, a spring mechanism, or any other suitable positioner may be used to rotate and/or translate light engine 14A.

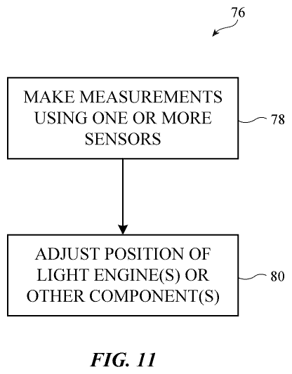

Regardless of the positioner(s) used for adjusting one or more light engines, an illustrative method of rotating and/or translating the light engine(s) is shown in FIG. 11.

As shown in method 76 of FIG. 11, at step 78, one or more sensors, such as sensors 18 of FIG. 1, of an electronic device, such as device 10 of FIG. 1, may make measurements. For example, a hall effect sensor, interferometer, encoder, strain gauge, inertial measurement unit (IMU), and/or other suitable sensor(s) may be used to measure a location of a light engine (e.g., light engine 14A) in the device. These measurements may be used to determine whether the light engine has shifted relative to an original location (or desired location) relative to a waveguide (e.g., waveguide 26).

Alternatively or additionally, one or more sensors may measure the output of a display that includes the light engine. For example, a camera or other optical sensor may measure output light 22 of FIG. 2, such as by redirecting some of the light using a secondary output coupler. These measurements may determine the brightness, distortion, white point, or other characteristic of the light output from the display.

At step 80, the position of the light engine(s) may be adjusted based on the sensor measurements. For example, if the position of the light engine(s) is measured and determined to have shifted or at an undesirable position, the position of the light engine(s) may be adjusted. In particular, the light engine(s) may be moved in one or more directions (e.g., any one or more of the directions shown in FIG. 3, or along the Z-axis).

The light engine(s) may be rotated and/or translated using one or more of the positioners of FIGS. 4-10, or other suitable positioners. For example, a motor, electronic actuator, or other electronic component may be used to move the light engine(s) using the positioners. In particular, control circuitry (such as control circuitry 16 of FIG. 1) in the electronic device may send signals to the motor or other component to adjust the position of the light engine(s), such as to tighten a fastener (FIG. 4), move a flexure (FIG. 5), move the light engine(s) about a hinge (FIG. 6), move the light engine(s) along a rail, such as by using a lead screw (FIG. 7), adjust a cam system (FIG. 8), adjust a rack and pinion system (FIG. 9), adjust a piezoelectric actuator (FIG. 10), and/or otherwise adjust the position of the light engine(s). In this way, the light engine(s) may be repositioned with respect to the waveguide.

As an alternative to repositioning the light engine(s) to counteract shifting of the light engine(s), the light engine(s) may be moved to adjust the output of the display. In particular, the light engine(s) may be rotated and/or translated to adjust the brightness, the resolution, the white point, or other characteristic(s) of the display. In some embodiments, the light engine(s) may be adjusted to transform the images. from the display, such as geometrically transforming the images.

The adjustments made at step 80 may be made while the electronic device is not being used, such as when the device is charging, when the device is sleeping or otherwise in a standby mode, or when the device is being powered on or off. Alternatively, the adjustments at step 80 may be made when the device is transitioning between environments, such as when the user is moving from indoors to outdoors, or when the content displayed by the display is changing, such as between text and video. However, these examples are merely illustrative. In general, the position of light engine(s) in the device may be adjusted during any suitable operation of the device.

Although FIG. 11 describes the automatic adjustment of the light engine(s) based on sensor measurements, this is merely illustrative. If desired, the light engine(s) may be adjusted automatically based on any suitable input, such as a change in the settings of device 10, or the content displayed on a display in device 10, as examples. Alternatively or additionally, the light engine(s) may be adjusted manually, such as by manually tightening a fastener (FIG. 4), moving a flexure (FIG. 5), moving the light engine(s) about a hinge (FIG. 6), moving the light engine(s) along a rail, such as by using a lead screw (FIG. 7), adjusting a cam system (FIG. 8), adjusting a rack and pinion system (FIG. 9), and/or otherwise manually adjusting the position of the light engine(s). After the position of the light engine(s) has been adjusted, the position of the light engine(s) may be locked into place. For example, a lock nut, a series of detents and/or a re-workable adhesive may be used to maintain the position of light engine relative to the waveguide.

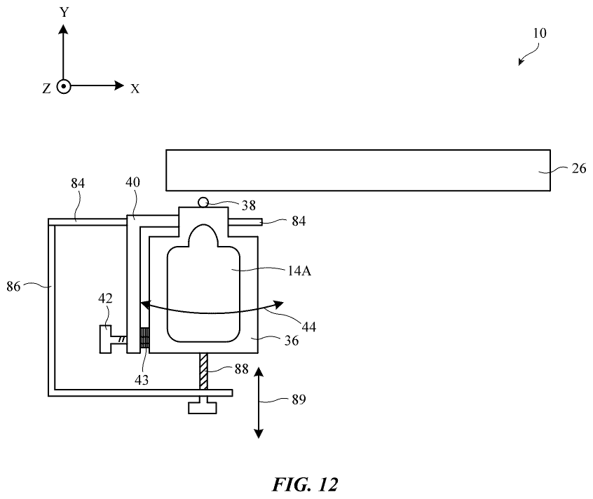

As discussed, multiple positioners may be incorporated into an electronic device to adjust the position of a light engine in more than one direction. An illustrative example is shown in FIG. 12.

As shown in FIG. 12, fastener 42 may be used to adjust light engine 14A along curve 44 (e.g., as shown in FIG. 4). Additionally, fastener 88 may be used to translate light engine 14A laterally in directions 89 (e.g., in the +Y and −Y directions). Members 84 and 86 may be coupled to mount 36, and fastener 88 may pass through member 86 into the back of mount 36. For example, fastener 88 may be a screw, pin, or other suitable fastener. By tightening and loosening fastener 88, either using a motor or manually, mount 36 may be moved in directions 89, thereby moving light engine 14A closer and further from waveguide 26.

Although not shown in FIG. 12, a locking mechanism may be used to lock mount 36 (and therefore light engine 14A) into a desired position. For example, a lock nut may be used at the end of fastener 42 and/or fastener 88 to maintain the position of fastener 42. Alternatively or additionally, a series of detents may be incorporated, such as at rotational pivot point 38 or within mount 36, to maintain the position of mount 36 at a certain angle or at a certain lateral position, and/or a re-workable adhesive may be used to maintain the position of mount 36. In this way, light engine 14A may be repositioned (e.g., the angle of light engine 14A relative to waveguide 26 may be adjusted, and/or light engine 14A may be moved further or closer to waveguide 26), and light engine 14A may be locked at a desired position.

Although FIG. 12 shows fastener 42 to rotate light engine 14A along curve 44 and fastener 88 to translate light engine 14A along the Y-axis, this is merely illustrative. If desired, a curved rail (e.g., curved rail 56 of FIG. 7) or another suitable mechanism may be used to allow light engine 14A to be rotated in multiple directions.

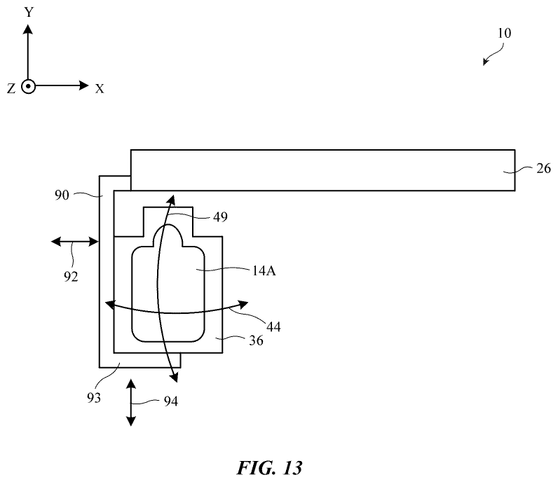

As another illustrative example, multiple flexures may be used to adjust a light engine in multiple directions. As shown in the illustrative example of FIG. 13, flexure 93, which may be formed from copper, gold, silver, or other suitable flexible material, may extend from flexure 90 (previously discussed in connection with FIG. 5). In addition to flexure 90 being movable along directions 92 to rotate light engine 14A along curve 44, flexure 93 may be movable along directions 94 to rotate light engine 14A along curve 49. However, this is merely illustrative. If desired, flexure 93 may be used to allow light engine 14A to rotate in the Z-direction.

The examples of FIGS. 12 and 13 are merely illustrative of combinations of positioners that may be used to rotate and/or translate a light engine in multiple directions. In general, any suitable positioners, such as any of the positioners in FIGS. 4-10, may be combined to move a light engine in multiple directions. By combining positioners in this way, a locking mechanism may be omitted, as the two positioners may effectively lock the light engine when they are not being adjusted. One or more locking mechanisms may be incorporated, however, if desired.

Although FIGS. 4-13 have shown light engine 14A on mount 36, which is adjusted by one or more positioners, this is merely illustrative. If desired, light engine 14A may be adjusted by the positioners directly (e.g., the positioners may be in direct contact with light engine 14A), or multiple structures may be incorporated between the positioners and light engine 14A.

Moreover, although FIGS. 3-13 have described adjusting light engine 14A, this is merely illustrative. In some embodiments, individual components within light engine 14A, such as one or more lenses, one or more light sources, and/or one or more prisms, may be adjusted. For example, one or more of these individual components may be rotated and/or laterally translated with respect to waveguide 26, such as using one or more of the positioners in FIGS. 4-10. Alternatively or additionally, a lens barrel that overlaps an eye box (e.g., lens barrel 25 of FIG. 2) may be rotated and/or laterally translated with respect to waveguide 26. In this way, the image displayed to the eye box may be corrected or otherwise adjusted.

The foregoing is merely illustrative and various modifications can be made to the described embodiments. The foregoing embodiments may be implemented individually or in any combination.

What is claimed is:

1. An electronic device, comprising:
a head-mounted support structure; and
a display coupled to the head-mounted support structure, the display comprising:
a light engine configured to emit light,
a waveguide having an input coupler configured to couple the light into the waveguide and having an output coupler configured to couple the light out of the waveguide and toward an eye box, and
a positioner coupled to the light engine, wherein the positioner is configured to rotate the light engine relative to the waveguide.

2. The electronic device of claim 1, wherein the positioner is further configured to translate the light engine laterally relative to the waveguide.

3. The electronic device of claim 1, wherein the light engine is coupled to a mount, and the positioner comprises:
a fastener coupled to the mount, wherein the light engine is configured to be rotated by adjusting the fastener.

4. The electronic device of claim 3, wherein the fastener passes through an opening in a portion of the head-mounted support structure, the electronic device further comprising:
a biasing spring interposed between the portion of the head-mounted support structure and the mount.

5. The electronic device of claim 3, wherein the mount has a front facing the waveguide, an opposing rear, and sides that extend from the front to the rear, wherein the fastener is a first fastener coupled to one of the sides of the mount, and the positioner further comprises:
a second fastener coupled to the rear of the mount, wherein the light engine is configured to be translated laterally by adjusting the second fastener.

6. The electronic device of claim 1, wherein the light engine is coupled to a mount, and the positioner comprises:
a flexure coupled to the mount, wherein the light engine is configured to be rotated by bending the flexure.

7. The electronic device of claim 6, wherein the mount has a front facing the waveguide, an opposing rear, and sides that extend from the front to the rear, wherein the flexure is a first flexure coupled to one of the sides of the mount, and the positioner further comprises:
a second flexure coupled to the rear of the mount.

8. The electronic device of claim 1, wherein the positioner comprises a hinge between the waveguide and the light engine.

9. The electronic device of claim 8, wherein the hinge is a four-bar linkage hinge.

10. The electronic device of claim 1, wherein the positioner comprises a curved rail, and the light engine is configured to be rotated by moving the light engine along the curved rail.

11. The electronic device of claim 10, wherein the positioner further comprises a lead screw, and the light engine is configured to be moved along the curved rail by adjusting the lead screw.

12. The electronic device of claim 1, wherein the light engine is coupled to a mount, and the positioner comprises:
a cam and screw coupled to the mount, wherein the light engine is configured to be rotated by adjusting the cam and the screw.

13. The electronic device of claim 1, wherein the light engine is coupled to a mount, and the positioner comprises:
a pinion coupled to the mount; and
a rack that engages the pinion, wherein the light engine is configured to be rotated by moving the pinion along the rack.

14. The electronic device of claim 1, wherein the positioner comprises a piezoelectric actuator, and the piezoelectric actuator is configured to rotate the light engine in response to a voltage applied to the piezoelectric actuator.

15. The electronic device of claim 1, further comprising:
a sensor in the head-mounted support structure, wherein the sensor is configured to measure a position of the light engine relative to the waveguide.

16. The electronic device of claim 15, further comprising:
a motor in the head-mounted support structure, wherein the motor is configured to rotate the light engine in response to the measured position of the light engine.

17. The electronic device of claim 1, further comprising:
a sensor in the head-mounted support structure, wherein the sensor is configured to measure the light that is coupled out of the output coupler, and the light engine is configured to be rotated relative to the waveguide in response to the measured light.

18. A display, comprising:
a light engine configured to emit light;
a waveguide having an input coupler configured to couple the light into the waveguide and having an output coupler configured to couple the light out of the waveguide; and
a positioner coupled to the light engine, wherein the positioner is configured to adjust an angle of the light engine relative to the waveguide.

19. The display of claim 18, wherein the positioner is a first positioner, the display further comprising:
a second positioner configured to translate the light engine laterally with respect to the waveguide.

20. A head-mounted device, comprising:
a light engine configured to emit light;
a waveguide configured to guide the light to an eye box;
a first positioner configured to adjust a position of the light engine relative to the waveguide in a first direction; and
a second positioner configured to adjust the position of the light engine relative to the waveguide in a second direction that is different from the first direction.
